(19) United States
(12) Patent Application Publication
(10) Pub. No.: US 2004/0057708 A1
(43) Pub. Date: Mar. 25, 2004

(54) Flexible height paint curing apparatus and method

(76) Inventor: James S. Nelson, Mounds View, MN (US)

Correspondence Address: Patrick S. Yoder, Fletcher, Yoder & Van Someren, P.O. Box 692289, Houston, TX, 77269-2289, US

(21) Appl. No.: 10/254,163

(22) Filed: Sep. 25, 2002

(51) Int. Cl. F26B 3/30

(52) U.S. Cl. 392/412; 392/414; 392/415

(57) ABSTRACT

The present technique provides a system and method for finishing and curing a desired material applied to a surface of a target object, such as a vehicle. An adjustable arm assembly is used to position a curing device, such as a radiative curing mechanism, adjacent the surface having the desired material. The adjustable arm assembly has an arm structure, which is rotatable between minimum and maximum vertical positions. At a head of the arm structure, the adjustable arm assembly has an adjustable height mechanism to adapt the vertical range of the arm structure to a particular target object, such as a large-sized or small-sized object. The head may support any suitable finishing or curing device, such as an infrared lamp. The adjustable height mechanism may have a reversible coupling assembly, mutually exclusive high and low couplings, a pivotal offset coupling, a rail assembly, or any other suitable coupling having at least two different height options.

### BACKGROUND OF THE INVENTION

The present technique relates generally to finishing systems and, more particularly, to industrial finish curing systems. In specific, a system and method is provided for vertically adapting an adjustable arm assembly to position a mounted curing device in a desired curing position based on the height of a particular target object, such as differently sized vehicles.

Finish coatings, such as paint, are often applied to a product and subsequently cured via heating devices. In many finishing systems, the product is placed in a curing room, where heat is flowed through the room to dry the finish coatings that were applied to the product. Although such curing rooms may be practical for large-scale manufacturing, the typical small-scale facility may not have the space or resources to use such curing rooms. For example, automobile repair shops may not have sufficient space or financial resources to set up a curing room.

Accordingly, a technique is needed for finishing and curing a variety of products without requiring a special finishing or curing room.

### SUMMARY OF THE INVENTION

The present technique provides a system and method for finishing and curing a desired material applied to a surface of a target object, such as a vehicle. An adjustable arm assembly is used to position a curing device, such as a radiative curing mechanism, adjacent the surface having the desired material. The adjustable arm assembly has an arm structure, which is rotatable between minimum and maximum vertical positions. At a head of the arm structure, the adjustable arm assembly has an adjustable height mechanism to adapt the vertical range of the arm structure to a particular target object, such as a large-sized or small-sized object. The head may support any suitable finishing or curing device, such as an infrared lamp. The adjustable height mechanism may have a reversible coupling assembly, mutually exclusive high and low couplings, a pivotal offset coupling, a rail assembly, or any other suitable coupling having at least two different height options.

### BRIEF DESCRIPTION OF THE DRAWINGS

The foregoing and other advantages and features of the invention will become apparent upon reading the following detailed description and upon reference to the drawings in which:

FIG. 1 is a diagram illustrating an exemplary finishing system of the present technique;

FIG. 2 is a diagram illustrating an exemplary finish curing system of the present technique;

FIG. 3 is a flow chart illustrating an exemplary finishing and curing process of the system illustrated in FIGS. 1 and 2;

FIG. 4 is a perspective view of an exemplary adjustable arm assembly, curing device, and adjustable height mechanism of the finish curing system illustrated in FIG. 2;

FIG. 5 is a perspective view of an alternative embodiment of the finish curing system illustrated in FIG. 4; and FIGS. 6-9 are side views illustrating different height configurations of the finish curing system illustrated in FIGS. 4 and 5.

### DETAILED DESCRIPTION OF SPECIFIC EMBODIMENTS

The present technique provides a unique arm mounted curing device, which may be used to apply or cure a desired material applied to a surface of a variety of differently sized products. For example, instead of placing the product in a heated room, the present technique directly cures the desired material by positioning a curing device (e.g., an infrared heating lamp) directly adjacent the desired material. Moreover, the present technique uses a standard-sized rotatable arm with a height-adjustable end mechanism to accommodate the differently sized products. In automotive finishing applications, the height-adjustable end mechanism may have high and low offset positions to accommodate large-sized and small-sized vehicles. Accordingly, the height-adjustable end mechanism adapts the standard-sized rotatable arm to the particular height/size of the target product. The height-adjustable end mechanism also may be used to adapt the vertical range of the standard-sized rotatable arm to the particular working environment, such as a lift mounted position, a pallet mounted position, and so forth.

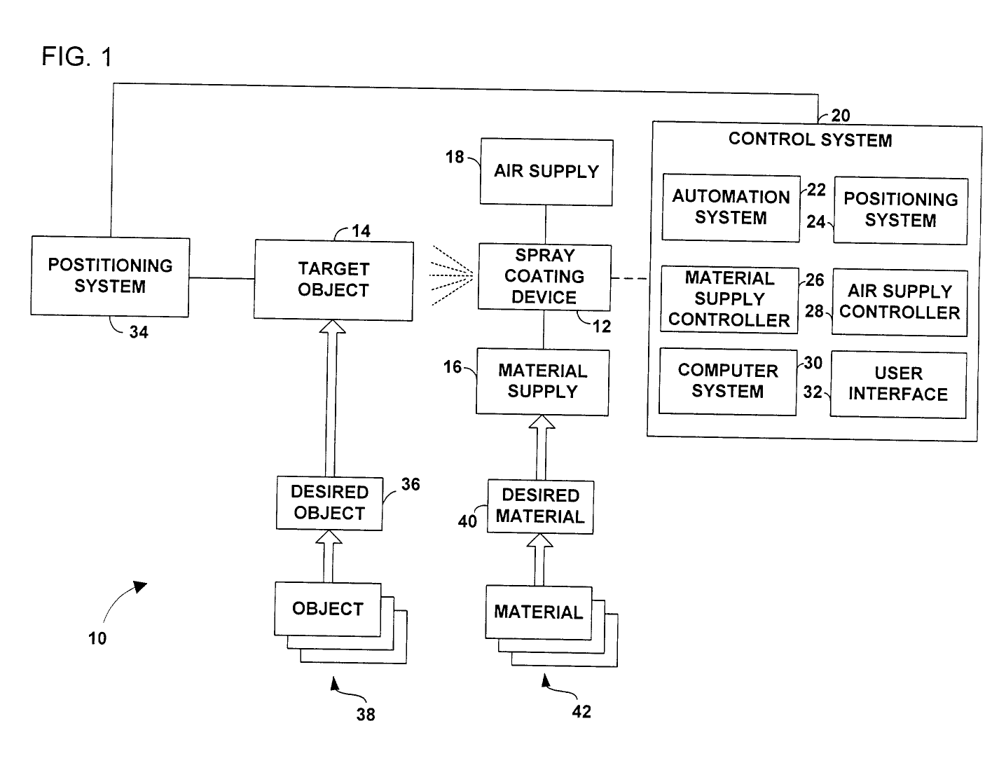

FIG. 1 is a flow chart illustrating an exemplary finishing system 10, which comprises a spray coating device 12 for applying a desired coating to a target object 14. For example, the spray coating device 12 may comprise an air atomizer, a rotary atomizer, an electrostatic atomizer, or any other suitable spray formation mechanism. The spray coating device 12 may be coupled to a variety of supply and control systems, such as a material supply 16 (e.g., a fluid or powder), an air supply 18, and a control system 20. The control system 20 facilitates control of the material and air supplies 16 and 18 and ensures that the spray coating device 12 provides an acceptable quality spray coating on the target object 14. For example, the control system 20 may include an automation system 22, a positioning system 24, a material supply controller 26, an air supply controller 28, a computer system 30, and a user interface 32. The control system 20 also may be coupled to a positioning system 34, which facilitates movement of the target object 14 relative to the spray coating device 12. For example, the positioning system 34 may comprise an assembly line, a hydraulic lift, a robotic arm, and a variety of other positioning mechanisms controlled by the control system 20. Accordingly, the finishing system 10 may provide a computer-controlled spray pattern across the surface of the target object 14.

The finishing system 10 of FIG. 1 is applicable to a wide variety of applications, fluid coating materials, powder coating materials, target objects, and types/configurations of the spray coating device 12. For example, a user may select a desired object 36 from a variety of different objects 38, such as different material and product types. The user also may select a desired material 40 from a plurality of different materials 42, which may include different coating types, colors, textures, and characteristics for a variety of materials such as metal and wood. For example, the desired material 40 may comprise a powder coating material, a fluid coating material (e.g., a paint), a filler material (e.g., body filler), and so forth. In one exemplary embodiment, the finishing system 10 may be incorporated into a vehicle assembly line or a vehicle repair facility.

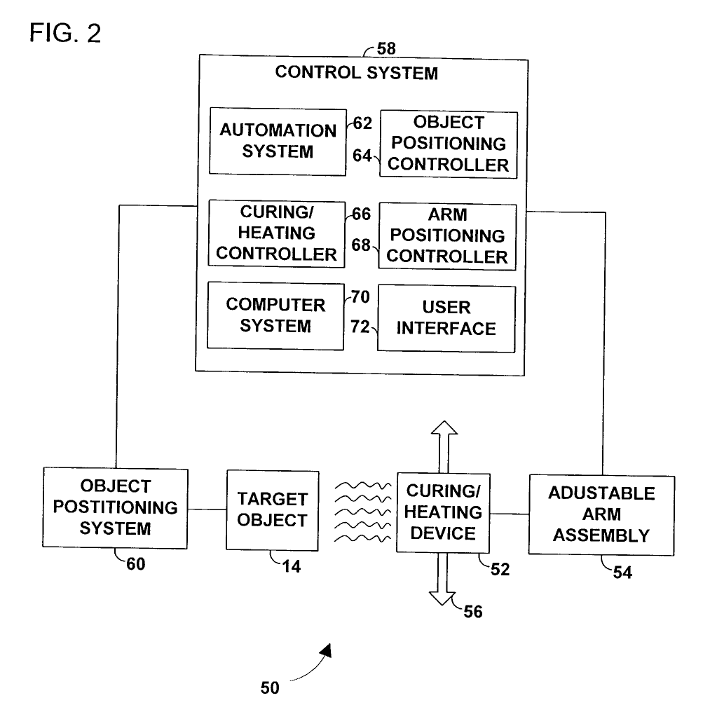

FIG. 2 is a flow chart illustrating an exemplary finish curing system 50, which comprises a curing device 52 for curing a desired material applied to the target object 14. For example, the curing device 52 may comprise one or more heating devices (e.g., radiative heating mechanisms, such as infrared lamps), drying devices, or other suitable curing mechanisms. In this exemplary embodiment, the curing device 52 is coupled to an adjustable arm assembly 54, which positions the curing device 52 in a desired curing position relative to the target object 14. The adjustable arm assembly 54 also has an adjustable height mechanism 56, which adapts the vertical range of the adjustable arm assembly 54 to the geometry of the particular target object 14. For example, the adjustable height mechanism 56 is movable between high and low positions to accommodate target objects (e.g., cars, trucks, boats, airplanes, or other vehicles) ranging from large-sized to small-sized.

The finish curing system 50 also may include a variety of positioning and control systems (e.g., manual or automatic), such as control system 58 and object positioning system 60. The control system 58 ensures that the desired material is efficiently and optimally cured onto the target object 14. For example, the control system 58 may include an automation system 62, an object positioning controller 64, a curing/heating controller 66, an arm positioning controller 68, a computer system 70, and a user interface 72. The control system 58 also may be coupled to the object positioning system 60, which facilitates movement of the target object 14 relative to the curing device 52. For example, the object positioning system 60 may comprise a manual positioning mechanism, an assembly line, a hydraulic lift, a robotic arm, and a variety of other 15 positioning mechanisms operated by the control system 58. Accordingly, the finish curing system 50 may automatically cure/dry the desired material to provide a cured surface material with the desired characteristics. However, the present technique also may operate without any automation controls and the target object may be stationary, such as a damaged vehicle in a repair shop. Accordingly, the present technique may produce a uniquely cured powder coating, fluid spray coating, filler material, adhesively-backed decal, or any other such material applied to the surface.

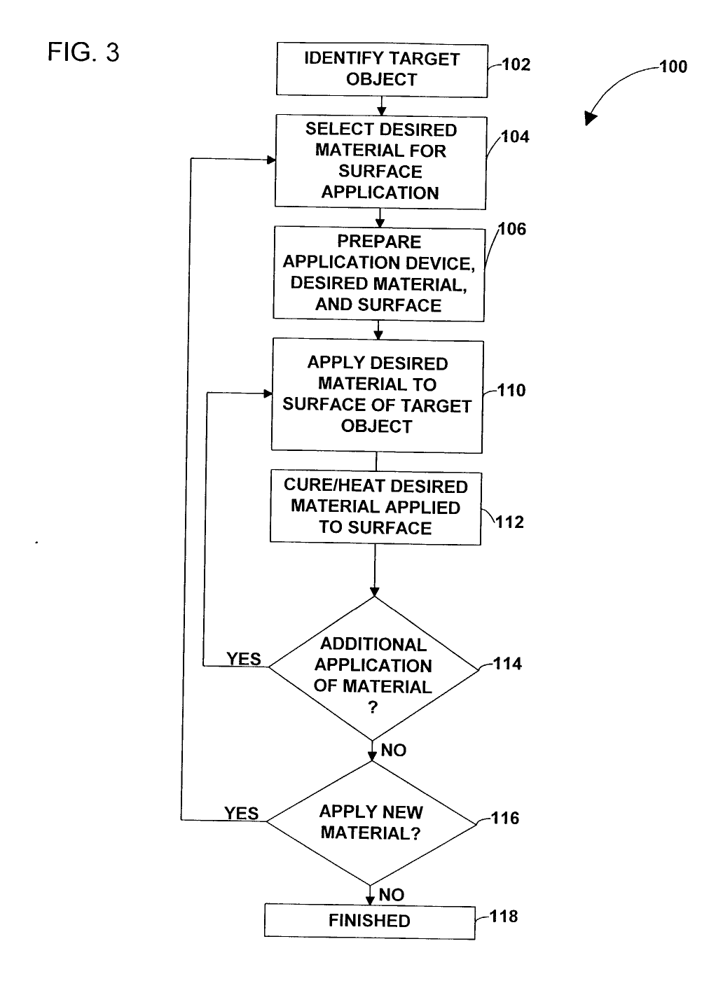

FIG. 3 is a flow chart of an exemplary finishing process 100 for applying and curing a desired material to the target object 14. As discussed above, the desired material may be a powder coating material, a fluid coating material, a filler material, or any other suitable surface applied material, including paints, varnishes, clear coats fillers, top coats, and so forth. As illustrated, the process 100 proceeds by identifying the target object 14 for application of the desired material (block 102). The process 100 then proceeds by selecting the desired material 40 for application to a surface of the target object 14 (block 104). A user may then proceed to configure the application device, the identified target object 14, and desired material (block 106). If the device is a spraying device, the process 100 then proceeds to create an atomized spray of the selected fluid or powder. The user may then apply the desired material over the desired surface of the target object 14 (block 110). The process 100 then proceeds to cure/dry the desired material that was applied over the desired surface (block 112). If the user desired an additional application of the desired material at query block 114, then the process 100 proceeds through blocks 110 and 112 to provide another application of the desired material. If the user does not desire an additional material application at query block 114, then the process 100 proceeds to query block 116 to determine whether the user desires a new material application. If a new material application is desired at query block 116, then the process 100 proceeds through blocks 104-114 using a new selected material. If the user does not desire a new material application at query block 116, then the process 100 is finished at block 118.

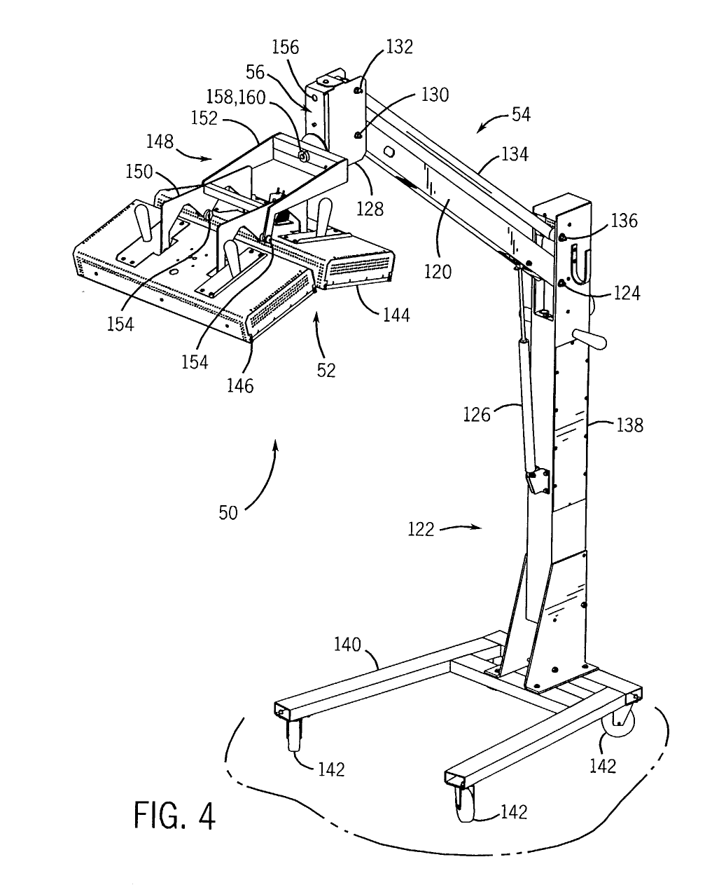

As described in further detail below, the foregoing systems 10 and 50 and the finishing process 100 may utilize a variety of positioning assemblies, such as the adjustable arm assembly 54. FIG. 4 is a perspective view of an exemplary embodiment of the finish curing system 50 having the curing device 52 coupled to the adjustable arm assembly 54 via the adjustable height mechanism 56. As illustrated, the adjustable arm assembly 54 comprises an arm structure 120 rotatably coupled to an arm support 122 via a pivot joint 124.

Although the arm structure 120 is illustrated as a single straight arm, the adjustable arm assembly 54 may have a multi-section arm and any suitable straight or curved geometry. The arm structure 120 also may have a variety of positioning control linkages to facilitate a desired vertical, lateral, and angular position. For example, the illustrated adjustable arm assembly 54 has an arm positioning linkage 126 extending between the arm support 122 and the arm structure 120, such that the arm structure 120 may be moved vertically in a range extending between minimum and maximum vertical positions. The adjustable arm assembly 54 also may have a variety of rotation-inducing mechanisms coupled to the arm structure 120, such that the arm structure 120 can be positioned in a desired angular position. In the illustrated embodiment, the adjustable arm assembly 54 has an adjustable end structure 128 rotatably coupled to the arm structure 120 at a pivot joint 130. At an adjacent pivot joint 132, the adjustable end structure 128 is rotatably coupled to an end positioning linkage 134 that is rotatably coupled to the arm support 122 via a pivot joint 136. As described with reference to FIG. 2, each of the foregoing linkages may comprises a variety of manual or automatic motion-inducing mechanisms, such as a hydraulic mechanism, a pneumatic mechanism, a geared mechanism, a motorized mechanism, a cable and pulley mechanism, or any other suitable mechanism.

The illustrated arm support 122 includes a vertical support 138 extending from a base structure 140, which has a plurality of wheels 142. However, the arm support 122 may comprise any suitable fixed or movable structure depending on the particular application. For example, the arm support 122 may be bolted or generally secured to a wall, a floor, a vehicle, a trailer, or any other suitable vertical, horizontal, or angled mounting structure. The arm support 122 also may have a manual or automatic positioning system, such as a rotational or linear positioning system to move the arm support 122 adjacent the target object 14. Accordingly, the adjustable arm assembly 54 can position the curing device 52 in a desired curing position relative to the target object 14.

The curing device 52, as illustrated in FIG. 4, includes a pair of heating/drying devices 144 and 146. The heating/drying devices 144 and 146 can have any suitable drying mechanism, such as conductive, convective, and radiative heat transfer mechanisms, which may cure a fluid coating, a powder coating, a filler, an adhesive, and so forth. For example, the heating/drying device 144 and 146 may comprise a fuel combustion heater, an electrical resistance heater, or an optical/light radiation heating mechanism, such as an infrared lamp. In this exemplary embodiment, the heating/drying devices 144 and 146 have infrared mechanisms. The heating/drying devices 144 and 146 are mounted to a head structure 148, which is coupled to the adjustable end structure 128 via the adjustable height mechanism 56. The illustrated head structure 148 has a fork-shaped extension 150 rotatably coupled to an E-shaped support 152 via a pivot joint 154. However, any suitable multi-section or integral support structure or yoke is within the scope of the present technique. The head structure 148 also may have a manual or automatic positioning system to pivot the E-shaped support 152 about the pivot joint 154.

At the adjustable end structure 128, the adjustable height mechanism 56 of FIG. 4 provides a high mounting position 156 and a low mounting position 158 for the head structure 148. In this exemplary embodiment, the head structure 148 is interchangeably and selectively mountable at either one of the high and low mounting positions 156 and 158 via a fastener 160. For example, the high and low mounting positions 156 and 158 may comprise female threads that can receive male threads of the fastener 160. The high and low mounting positions 156 and 158 also may include mechanical latches, hooks, or other releasable and interchangeable mount structures. The illustrated fastener 160 also may operate as a pivot joint for rotating the head structure 148 relative to the arm structure 120. A manual or automatic positioning system may then be coupled to the foregoing pivot joint to facilitate rotation of the head structure 148.

Alternatively, the adjustable height mechanism 56 may have a single mounting mechanism, such as an offset mounting structure, while the adjustable height mechanism 56 is reversibly and interchangeably mountable to the adjustable end structure 128. For example, the adjustable height mechanism 56 may be released, swiveled about a pivot joint, and then resecured to the adjustable end structure 128. The adjustable height mechanism 56 also may be detached, rotated 180 degrees, and then reattached to the adjustable end structure 128. Accordingly, by reversibly mounting the adjustable height mechanism 56 to the adjustable height mechanism 56, the head structure 148 can be mounted in a higher or lower position similar to those of the high and low mounting positions 156 and 158.

In either the multi-mount or single-mount configuration of the adjustable height mechanism 56, the height variance between the various mounting mechanisms may be selected to extend the adjustable arm assembly 54 beyond its minimum and maximum height. For example, if the prospective target objects 14 have a variety of dimensions, such as large-sized and small-sized, then the foregoing height variance can be tailored to the different heights of these differently sized target objects. In an automotive application, the height variance may be chosen to accommodate vehicles ranging from small cars to large trucks. The height variance also may accommodate different object positions, such as lift-mounted, trailer mounted, assembly line mounted, pallet-mounted, and so forth.

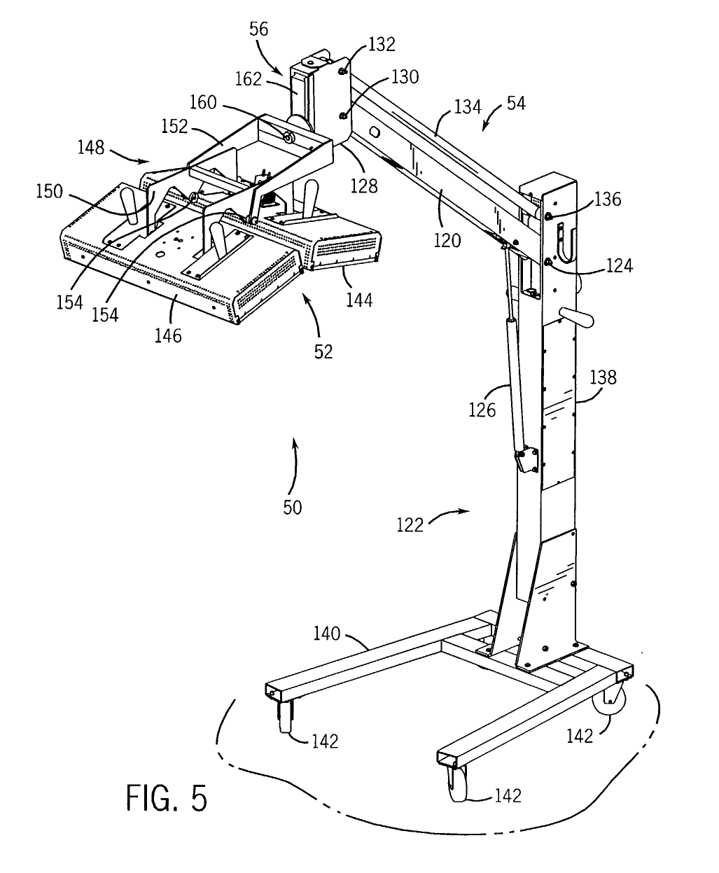

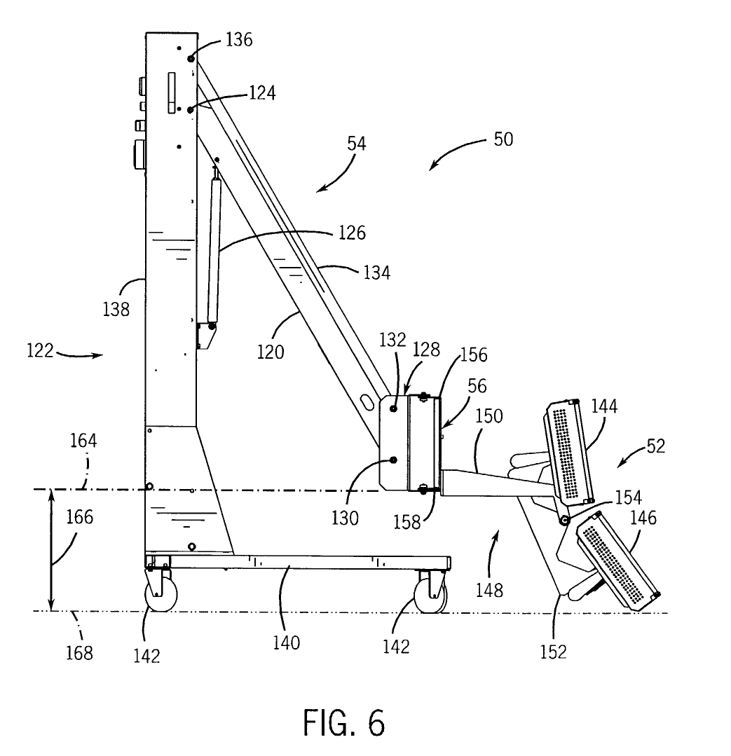

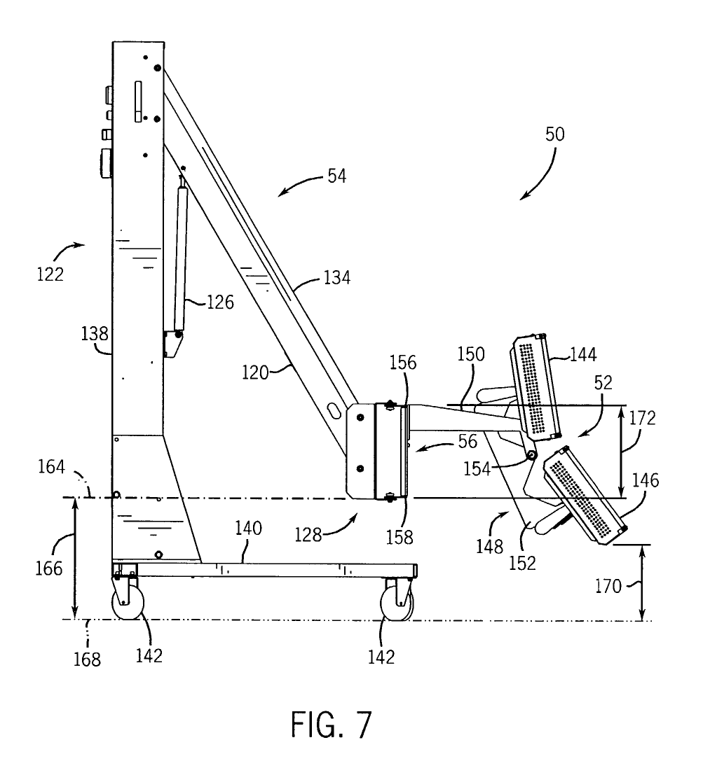

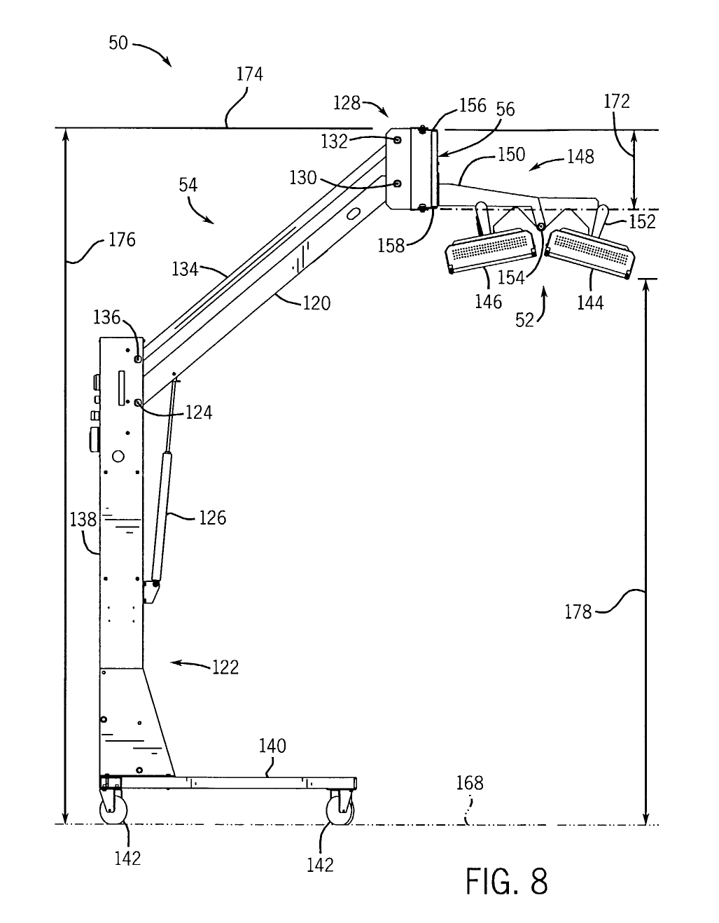

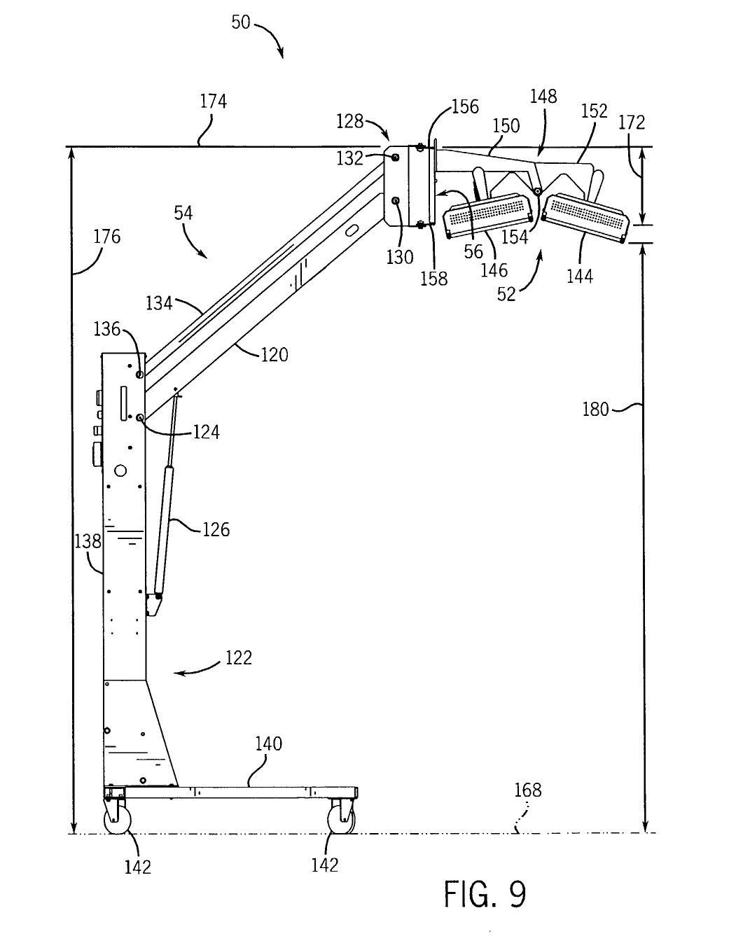

In a further alternative embodiment, the adjustable height mechanism 56 may comprise a linear positioning mechanism 162, as illustrated in FIG. 5. The linear positioning mechanism 162 may have a variety of manual or automatic motion-inducing mechanisms, such as a hydraulic mechanism, a pneumatic mechanism, a geared mechanism, a motorized mechanism, a cable and pulley mechanism, a rail and carrier mechanism, or any other suitable manually or automatically movable mechanism. Again, the vertical range of the linear positioning mechanism 162 may be tailored to the different heights and sizes of the prospective target objects 14.

In operation, the finish curing system 50 can position the head structure 148 and mounted curing device 52 adjacent low and high surfaces of various different target objects 14, such as small and large-sized vehicles. At each of these positions, the heating/drying devices 144 and 146 operate to cure the desired material applied to the surface of the target object 14. Again, the desired material may be a paint, a wax, a filler (e.g., body filler), a fluid or powder sprayed coating material, a brush applied coating material, a clear coat material, or any other suitable surface application materials. FIGS. 6-9 are side views illustrating exemplary configurations of the finish curing system 50 utilizing the adjustable height mechanism 56.

As illustrated in FIGS. 6 and 7, the system 50 can position the arm structure 120 in a minimum height position 164, which is disposed at a vertical distance 166 from a ground position 168. At this minimum height position 164, the adjustable height mechanism 56 vertically adapts the adjustable arm assembly 54 to the particular size and position of the target object 14. For example, the adjustable arm assembly 54 may move the head structure 148 and mounted curing device 52 to the low mounting position 158, as illustrated in FIG. 6. In the low mounting position 158, the curing device 52 is positionable at or below the ground level 168, such that the curing device 52 can cure the desired material at the base of the target object 14. For example, the low mounting position 158 may be particularly advantageous for small-sized vehicles, pallet-mounted vehicles, or other target objects 14 positioned near the ground level 168. As illustrated in FIG. 7, the adjustable arm assembly 54 also can move the head structure 148 and mounted curing device 52 to the high mounting position 156. In the high mounting position 156, the curing device 52 is positioned above the ground level 168 at a vertical height 170, which relates to a vertical offset 172 provided between the high and low mounting positions 156 and 158. Accordingly, the curing device 52 can cure the desired material at the base of a large-sized or high-positioned target object 14, such as a large vehicle, a lift-mounted vehicle, and so forth.

As illustrated in FIGS. 8 and 9, the system 50 also can position the arm structure 120 in a maximum height position 174, which disposes the arm structure 120 at a vertical distance 176 from the ground position 168. At this maximum height position 174, the adjustable height mechanism 56 vertically adapts the adjustable arm assembly 54 to the particular size and position of the target object 14. The finish curing system 50 also may rotate the curing device 52 to a downwardly facing orientation, which facilitates curing of a desired material disposed on an upper surface of the target object 14. If the target object 14 has a low topside, then the adjustable arm assembly 54 may move the head structure 148 and mounted curing device 52 to the low mounting position 158, as illustrated in FIG. 8. In this low mounting position 158, the heating/drying devices 144 and 146 are offset from the ground level 168 at a vertical distance 178. As described above, the low mounting position 158 may be particularly advantageous for small-sized vehicles, pallet-mounted vehicles, or other low to the ground target objects 14. The adjustable arm assembly 54 also can move the head structure 148 and mounted curing device 52 to the high mounting position 156, as illustrated in FIG. 9. In the high mounting position 156, the heating/drying devices 144 and 146 are disposed at a vertical height 180, which is higher than the vertical height 178 by the vertical offset 172. Accordingly, the curing device 52 can cure the desired material at the topside of a large-sized or high-positioned target object 14, such as a large vehicle, a lift-mounted vehicle, and so forth.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A positioning assembly for an automotive finishing system, comprising:
an arm assembly movable between high and low positions;
a head assembly having a mount assembly for a curing device;
a multi-height positioning mechanism pivotally coupling the head unit to the arm structure.

2. The positioning assembly of claim 1, wherein the multi-height positioning mechanism comprises a reversible coupling assembly having first and second orientations opposite from one another.

3. The positioning assembly of claim 2, wherein the head assembly is positionable in low and high positions in the respective first and second orientations.

4. The positioning assembly of claim 1, wherein the multi-height positioning mechanism comprises mutually exclusive high and low couplings.

5. The positioning assembly of claim 1, wherein the multi-height positioning mechanism comprises a sliding rail assembly having a plurality of different vertical positions.

6. The positioning assembly of claim 5, wherein the multi-height positioning mechanism comprises a linear positioning motor assembly coupled to the sliding rail assembly.

7. The positioning assembly of claim 5, wherein the multi-height positioning mechanism comprises a hydraulic assembly coupled to the sliding rail assembly.

8. The positioning assembly of claim 1, wherein the curing device comprises a heating apparatus.

9. The positioning assembly of claim 1, wherein the curing device comprises an infrared apparatus.

10. The positioning assembly of claim 1, wherein the head assembly comprises at least one support structure rotatably coupled to the mount assembly.

11. The positioning assembly of claim 1, wherein the mount assembly comprises a mounting structure for each of a plurality of components of the curing device.

12. A system for curing a fluid coating applied to a vehicle, comprising:
an arm assembly movable between high and low positions;
a multi-height positioning mechanism coupled to an end section of the arm assembly; and
a radiative curing device coupled to the multi-height positioning mechanism.

13. The system of claim 12, wherein the multi-height positioning mechanism comprises a reversible coupling assembly comprising first and second configurations having low and high coupling positions, respectively.

14. The system of claim 12, wherein the multi-height positioning mechanism comprises mutually exclusive high and low couplings.

15. The system of claim 12, wherein the multi-height positioning mechanism comprises a linear positioning mechanism.

16. The system of claim 12, wherein the radiative curing device comprises a drying mechanism.

17. The system of claim 12, wherein the radiative curing device comprises an infrared lamp.

18. The system of claim 12, wherein the radiative curing device comprises a plurality of positionable heaters.

19. The system of claim 12, wherein the multi-height positioning mechanism is pivotally coupled to the end section via a pivot assembly.

20. The system of claim 12, wherein the radiative curing device is rotatably coupled to the multi-height positioning mechanism via a rotatable joint assembly.

21. A system for curing a desired material applied to a surface, comprising:
a pivotal arm movable between high and low positions; and
a curing head assembly coupled to the pivotal arm via multi-height positioning means for positioning the curing head assembly in one of a plurality of heights relative to the pivotal arm.

22. The system of claim 21, wherein the curing head assembly comprises a radiative heating mechanism.

23. The system of claim 22, wherein the radiative heating mechanism comprises an infrared heating lamp.

24. The system of claim 22, wherein the radiative heating mechanism comprises a plurality of positionable heating lamps.

25. The system of claim 21, wherein the pivotal arm comprises primary positioning means for orienting the curing head assembly at a desired position.

26. The system of claim 21, wherein the curing head assembly comprises a curing device disposed in a yoke, which has at least one rotatable joint.

27. A method of forming a positionable curing system for a desired material applied to a surface, comprising the acts of:
providing a height adjustable arm;
providing a heating device;
forming a multi-height positioning mechanism having at least two different vertical positions; and
coupling the heating device to the height adjustable arm via the multi-height positioning mechanism.

28. The method of claim 27, wherein the act of providing the height adjustable arm comprises the act of adapting the height adjustable arm to a standard automotive finishing system.

29. The method of claim 27, wherein the act of providing the heating device comprises the act of mounting the heating device to a rotatable head structure.

30. The method of claim 27, wherein the act of providing the heating device comprises the act of supporting at least one radiative heating mechanism in a yoke.

31. The method of claim 27, wherein the act of coupling the heating device comprises the act of supporting an infrared heating lamp.

32. The method of claim 27, wherein the act of forming the multi-height positioning mechanism comprises the act of creating a reversible coupling mechanism having first and second orientations opposite from one another.

33. The method of claim 27, wherein the act of forming the multi-height positioning mechanism comprises the act of creating mutually exclusive high and low couplings.

34. The method of claim 27, wherein the act of forming the multi-height positioning mechanism comprises the act of creating a sliding rail mechanism having a plurality of different vertical positions.

35. The method of claim 34, wherein the act of creating the sliding rail mechanism comprises the act of operably coupling a linear positioning motor to the sliding rail mechanism.

36. The method of claim 34, wherein the act of creating the sliding rail mechanism comprises the act of operably coupling a hydraulic mechanism to the sliding rail mechanism.

37. A method of curing a desired material applied to a surface of a vehicle, comprising the acts of:
engaging a heating device supported by a head structure coupled to a rotatable arm via a height-adjustable coupling mechanism;
rotating the rotatable arm between high and low portions of the vehicle;
vertically adjusting the height-adjustable coupling mechanism based on dimensions of the vehicle; and
radiating a curing heat from the heating device to the desired material applied to the surface.

38. The method of claim 37, wherein the act of engaging the heating device comprises the act of initiating an infrared heating lamp.

39. The method of claim 37, wherein the act of vertically adjusting the height-adjustable coupling mechanism comprises the act of switching a reversible coupling between first and second orientations.

40. The method of claim 37, wherein the act of vertically adjusting the height-adjustable coupling mechanism comprises the act of repositioning the head structure between mutually exclusive couplings of the height-adjustable coupling mechanism.

41. The method of claim 37, wherein the act of vertically adjusting the height-adjustable coupling mechanism comprises the act of moving the head structure along a vertical rail structure.

42. The method of claim 37, wherein the act of vertically adjusting the height-adjustable coupling mechanism comprises the act of raising the height-adjustable coupling mechanism to increase a maximum height of the rotatable arm to accommodate a large-sized vehicle.

43. The method of claim 37, wherein the act of vertically adjusting the height-adjustable coupling mechanism comprises the act of lowering the height-adjustable coupling mechanism to decrease a minimum height of the rotatable arm to accommodate a small-sized vehicle.

44. The method of claim 37, wherein the act of rotating the rotatable arm comprises the act of coordinating the heating device over the vehicle in a vehicle assembly line.

45. The method of claim 37, wherein the act of rotating the rotatable arm comprises the act of coordinating the heating device over the vehicle in a vehicle repair shop.

46. The method of claim 37, wherein the act of radiating the curing heat comprises the act of curing a powder coating of the desired material.

47. The method of claim 37, wherein the act of radiating the curing heat comprises the act of curing a sprayed fluid coating of the desired material.

48. The method of claim 37, wherein the act of radiating the curing heat comprises the act of curing a thin film of the desired material.

49. The method of claim 37, wherein the act of radiating the curing heat comprises the act of curing a body filler of the desired material.

50. The method of claim 37, wherein the act of radiating the curing heat comprises the act of heating an adhesive-backed decal having the desired material.

51. A coating cured by the method of claim 37.

52. A filler cured by the method of claim 37.

53. A film cured by the method of claim 37.

54. A decal heated by the method of claim 37.
